(19) United States
(12) Patent Application Publication
(10) Pub. No.: US 2021/0102744 A1
(43) Pub. Date: Apr. 8, 2021

(54) SYSTEM FOR DETERMINING LOADING LEVEL OF REFRIGERATION APPLIANCE

(71) Applicant: TECO Electric & Machinery Co., Ltd., Taipei City (TW)

(72) Inventors: Po-Yao HSIEH, Taipei City (TW); Chih-Hung HSIAO, Taipei City (TW); Ifan SUN, Taipei City (TW)

(21) Appl. No.: 16/690,637

(22) Filed: Nov. 21, 2019

(30) Foreign Application Priority Data
Oct. 8, 2019 (TW) 108136336

(51) Int. Cl. F25D 23/02; F25D 23/12

(52) U.S. Cl. CPC F25D 23/028; F25D 17/065; F25D 23/126

(57) ABSTRACT

A system for determining a loading level of a refrigeration appliance includes a plurality of refrigeration appliances, a plurality of detection modules, a server, and a plurality of play modules. The detection module is utilized to sense a plurality of refrigeration parameters and downtime of the refrigeration appliances. The server is utilized to determine the loading level of each refrigeration appliance with the same refrigeration parameter or downtime. The play module is utilized to play loading-level information corresponding to the specific loading level.

This application claims the benefit of Taiwan Patent Application Serial No. 108136336, filed on Oct. 8, 2019, the subject matter of which is incorporated herein by reference.

### BACKGROUND OF THE INVENTION

### (1) Field of the Invention

The invention relates to a system, and more particularly to a system that is utilized for determining a loading level of a refrigeration appliance.

### (2) Description of the Prior Art

As one of popular domestic appliances, a refrigeration appliance such as a refrigerator, a refrigeration compartment or a freezer, is widely used in a normal house, an office, a restaurant, a fast food store, a Chinese medicine pharmacy and an ordinary commercial site. In particular, a location may include plural refrigeration appliances simultaneously. Nevertheless, due to some specific reasons such as application sites or usage purposes, it is quite possible that a single refrigeration appliance may be overloaded by excessive food storage, or degraded in refrigeration function by frequent door opening and closing. In this scenery, the refrigeration appliance would consume more energy than expected.

### SUMMARY OF THE INVENTION

In the art, due to knowledge shortage about operational information of refrigeration appliances, a single refrigeration appliance may be overloaded or degraded by excessive food storage or frequent door open/close, respectively. Thereupon, this refrigeration appliance would consume more electric energy than expected. Accordingly, it is an object of the present invention to provide a system for determining a loading level of a refrigeration appliance that can resolve at least one of the aforesaid shortcomings.

In the present invention, the system for determining a loading level of a refrigeration appliance, includes a plurality of refrigeration appliances, a plurality of detection modules, a server and a plurality of play modules.

Each of the plurality of refrigeration appliances runs for a cycle number of work cycles within a statistic time duration, and each of the work cycles has a work-cycling time and a refrigeration parameter. The work-cycling time is consisted of a refrigeration time and a downtime, and a most recent work cycle of the work cycles is defined as a preceding work cycle. The refrigeration parameter and the downtime corresponding to the preceding work cycle are defined as a preceding refrigeration parameter and a preceding downtime, respectively. Each of the plurality of detection modules is utilized for detecting the cycle number of each of the plurality of refrigeration appliances, and for detecting the refrigeration parameter and the downtime for each of the work cycles.

The server, coupled signally with the plurality of refrigeration appliances and the plurality of detection modules, is utilized for receiving the cycle number, the refrigeration parameter and the downtime for each of the work cycles, the preceding refrigeration parameter and the preceding downtime of each of the plurality of refrigeration appliances. The server further includes a calculation module and a processing module.

The calculation module is utilized for averaging individually the refrigeration parameters and the downtime for all the work cycles within the statistic time duration to obtain a refrigeration parameter average and a downtime average. The processing module, coupled signally with the calculation module, is utilized for generating a comparison result upon the refrigeration parameters by comparing the preceding refrigeration parameters and the refrigeration parameter average, for generating a comparison result upon the downtime by comparing the preceding downtime and the downtime average, and for searching an initial-stage loading level for each of the plurality of refrigeration appliances from a state-checking table according to the comparison result upon the refrigeration parameters and the comparison result upon the downtime.

Each of the play modules, disposed individually at the corresponding refrigeration appliance, is utilized for playing individual initial-level information corresponding to the respective initial-stage loading level for each of the plurality of refrigeration appliances.

In one embodiment of the present invention, the processing module includes a memory unit for storing the state-checking table.

In one embodiment of the present invention, the processing module includes a first processing unit for locating the initial-stage loading level for each of the plurality of refrigeration appliances from the state-checking table so as to obtain a plurality of the initial-stage loading levels.

In one embodiment of the present invention, the processing module further includes a first determining unit and a second processing unit. The first determining unit, coupled signally with the first processing unit, is utilized for generating a first processing signal upon when at least two of the plurality of the initial-stage loading levels are identical. The second processing unit, coupled signally with the first determining unit, is utilized for further comparing the preceding downtime for the plurality of refrigeration appliances with the same initial-stage loading level, upon when the first processing signal is received, so as to obtain a first advanced-stage loading level for each of the plurality of refrigeration appliances, and to have each of the plurality of play modules to further play first advanced-stage information corresponding to the first advanced-stage loading level for the respective each of the plurality of refrigeration appliances.

In one embodiment of the present invention, the processing module further includes a second determining unit and a third processing unit. The second determining unit, coupled signally with second processing unit, is utilized for generating a second processing signal upon when at least two of the plurality of the first advanced-stage loading levels are identical. The third processing unit, coupled signally with second determining unit, is utilized for further comparing the refrigeration parameters for the plurality of refrigeration appliances with the same first advanced-stage loading level, upon when the second processing signal is received, so as to obtain a second advanced-stage loading level for each of the plurality of refrigeration appliances, and to have each of the plurality of play modules to further play second advanced-stage information corresponding to the second advanced-stage loading level for the respective each of the plurality of refrigeration appliances.

In one embodiment of the present invention, each of the plurality of detection modules includes a door-open/close detecting unit for detecting a preceding door-close time interval of a corresponding one of the plurality of refrigeration appliances.

In one embodiment of the present invention, the processing module further includes a third determining unit and a fourth processing unit. The third determining unit, coupled signally with third processing unit, is utilized for generating a third processing signal upon when at least two of the plurality of the second advanced-stage loading levels are identical. The fourth processing unit, coupled signally with third determining unit, is utilized for further comparing the preceding door-close time intervals for the plurality of refrigeration appliances with the same second advanced-stage loading level, upon when the third processing signal is received, so as to obtain a final-stage loading level for each of the plurality of refrigeration appliances, and to have each of the plurality of play modules to further play final-stage information corresponding to the final-stage loading level for the respective each of the plurality of refrigeration appliances.

In one embodiment of the present invention, each of the plurality of play modules includes a displaying unit for playing the initial-level information.

In one embodiment of the present invention, each of the plurality of play modules includes a speaking unit for voice playing the initial-level information.

In one embodiment of the present invention, each of the plurality of play modules includes a detecting unit coupled signally with the speaking unit and utilized for activating the speaking unit to generate a trigger signal for initiating broadcasting of the corresponding initial-level information.

As stated, the system for determining a loading level of a refrigeration appliance provided by the present invention introduces the detection modules, the server and the play modules to search an initial-stage loading level fir each of the refrigeration appliances. Thereupon, a priority for arranging food materials into the refrigeration appliances can be determined, and thereby the long-concerned shortcomings in freshness of food materials caused by excessive food storage and frequent door opening, and energy consumption to a specific refrigeration appliance can be substantially resolved.

All these objects are achieved by the system for determining a loading level of a refrigeration appliance described below.

### BRIEF DESCRIPTION OF THE DRAWINGS

The present invention will now be specified with reference to its preferred embodiment illustrated in the drawings, in which:

FIG. 1 is a schematic view of a first embodiment of the system for determining a loading level of a refrigeration appliance in accordance with the present invention;

FIG. 2A and FIG. 2B together show schematically a block view of FIG. 1;

FIG. 3 demonstrates schematically initial-level information of FIG. 1;

FIG. 4A and FIG. 4B together show schematically a block view of a second embodiment of the system for determining a loading level of a refrigeration appliance in accordance with the present invention;

FIG. 5 is a schematic block view of the processing module of the second embodiment of FIG. 4A and FIG. 4B; and

FIG. 6 is a schematic view of the second embodiment of FIG. 4A and FIG. 4B.

### DESCRIPTION OF THE PREFERRED EMBODIMENT

The invention disclosed herein is directed to a system for determining a loading level of a refrigeration appliance. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

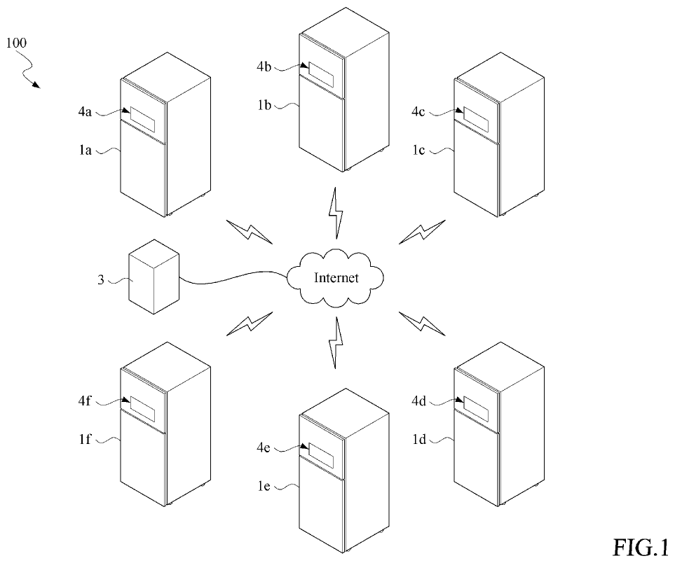

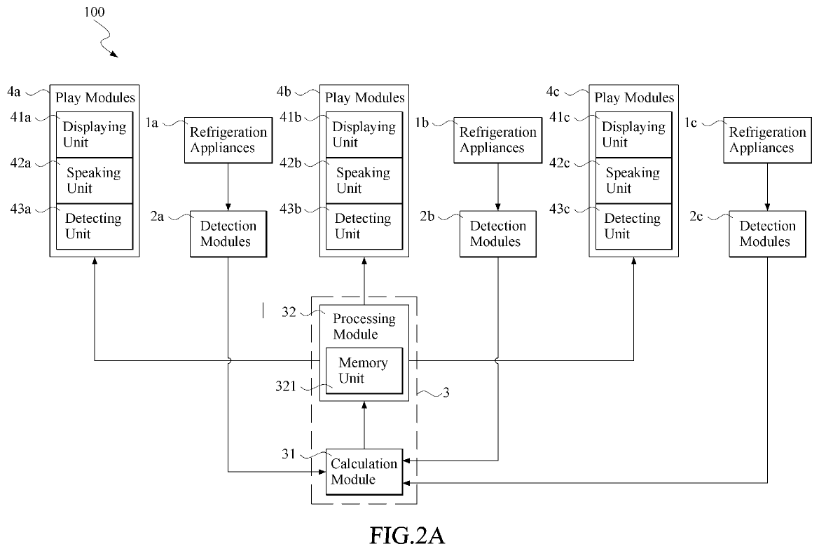

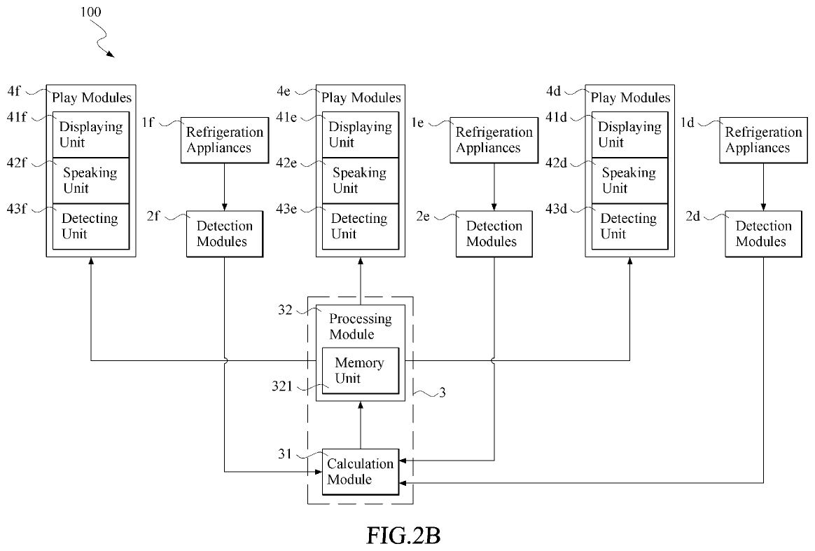

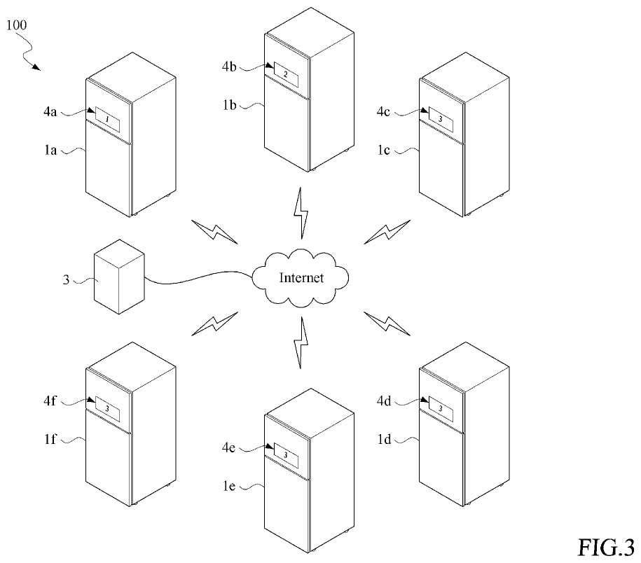

Refer to FIG. 1 through FIG. 3; where FIG. 1 is a schematic view of a first embodiment of the system for determining a loading level of a refrigeration appliance in accordance with the present invention, FIG. 2A and FIG. 2B together show schematically a block view of FIG. 1, and FIG. 3 demonstrates schematically initial-level information of FIG. 1. As shown, the system 100 utilized for determining loading levels of corresponding refrigeration appliances includes a plurality of refrigeration appliances (six 1a, 1b, 1c, 1d, 1e, 1f shown in the figure), a plurality of detection modules (six 2a, 2b, 2c, 2d, 2e, 2f shown in the figure), a server 3 and a plurality of play modules (six 4a, 4b, 4c, 4d, 4e, 4f shown in the figure). Any of the refrigeration appliances 1a, 1b, 1c, 1d, 1e, 1f can be a refrigerator, a refrigeration compartment, a freezer, a transparent showcase or any the like apparatus with a refrigeration function.

The detection modules 2a, 2b, 2c, 2d, 2e, 2f are individually disposed at the refrigeration appliances 1a, 1b, 1c, 1d, 1e, 1f, respectively. Each of the detection modules 2a, 2b, 2c, 2d, 2e, 2f is coupled signally with the server 3. The play modules 4a, 4b, 4c, 4d, 4e, 4f, disposed individually at the corresponding refrigeration appliances 1a, 1b, 1c, 1d, 1e, 1f, are also respectively coupled signally with the server 3.

By taking the refrigeration appliance 1a and the detection module 2a as the exemplary examples, within a statistic time duration, the refrigeration appliance 1a would run for a cycle number of work cycles. Each of the work cycles is defined with a work-cycling time and a refrigeration parameter, in which the work-cycling time is consisted of a refrigeration time and a downtime. In these work cycles, the most recent work cycle is defined as a preceding work cycle, and the refrigeration parameter and downtime corresponding to the preceding work cycle is defined as a preceding refrigeration parameter and a preceding downtime, respectively. Similarly, the foregoing arrangement prevails to each of the refrigeration appliances 1b, 1c, 1d, 1e, 1f.

The detection modules 2a is utilized for detecting the cycle number of the refrigeration appliances 1a so as further to determine corresponding refrigeration parameter and downtime for the refrigeration appliances 1a at each of the work cycles, In the present invention, the detection module can be a sensor, software, hardware or a combination of above that can realize the refrigeration parameter and the downtime. Similarly, the foregoing arrangement prevails to each of the detection modules 2b, 2c, 2d, 2e, 2f. In this embodiment, the refrigeration parameter for a specific statistic time of the refrigeration appliance is particularly defined by a sum of individual products of the rotational speeds and the corresponding running time of the refrigeration appliance within the refrigeration time. The rotational speed is a rotational speed of a compressor in a unit of revolutions per minute (RPM). In other embodiments, the rotational speed can be in a unit of revolutions per second, revolutions per hour or Hz. Generally speaking, a normal running time of the compressor is ranging from 40 to 60 minutes, and the downtime is ranging from 20 to 40 minutes. In addition, a normal rotational speed of a fixed-frequency compressor is about 3600 rpm, but the rotational speed of an inverter compressor is adjustable.

The server 3, including a calculation module 31 and a processing module 32, is utilized for receiving the cycle numbers, the refrigeration parameters and the downtime detected from the detection modules 2a, 2b, 2c, 2d, 2e, 2f.

The calculation module 31 would average separately all the refrigeration parameters and all the downtime within the statistic time duration, so as to obtain correspondingly a refrigeration parameter average and a downtime average, respectively. As shown in Table 1, the statistic time duration can be a day, a week, a month, a season or any specific time period, and the downtime can be in a unit of second (sec), minute (min) or hour (hr).

TABLE 1

| | Preceding | | Refrig- | |
|---|---|---|---|---|
| | refrig- | Preceding | eration | Downtime |
| Refrigeration | eration | downtime | parameter | average |
| appliance | parameter | (min) | average | (min) |
| 1a | 60000 | 30 | 65000 | 35 |
| 1b | 60000 | 20 | 65000 | 35 |
| 1c | 180000 | 40 | 65000 | 35 |
| 1d | 135000 | 30 | 65000 | 35 |
| 1e | 90000 | 30 | 65000 | 35 |
| 1f | 135000 | 30 | 65000 | 35 |

The processing module 32, coupled signally with the calculation module 31, is utilized for comparing the preceding refrigeration parameter and the refrigeration parameter average so as to generate a comparison result upon the refrigeration parameters, and also for comparing the preceding downtime and the downtime average so as to generate a comparison result upon the downtime. When the preceding refrigeration parameter is greater than the refrigeration parameter average, the comparison result upon the refrigeration parameters would be labeled with a signal “Busy”. Otherwise, the comparison result upon the refrigeration parameter would be labeled with a signal “Idle”. When the preceding downtime is smaller than the downtime average, the comparison result upon the downtime would be labeled with another “Busy”. Otherwise, the comparison result upon the downtime is labeled with another “Idle”. Then, the processing module 32 would determine loading levels for the corresponding refrigeration appliances 1a, 1b, 1c, 1d, 1e, 1f by searching a state-checking table according to the comparison result upon the refrigeration parameters and the comparison result upon the downtime. For example, the state-checking table can be one as the following Table 2.

TABLE 2

| | Comparison result | |
|---|---|---|
| | upon Refrigeration | Comparison result |
| Loading level | parameters | upon Downtime |
| 4 | Busy | Busy |
| 3 | Busy | Idle |
| 2 | Idle | Busy |
| 1 | Idle | Idle |

In this embodiment, the processing module 32 includes a memory unit 321 for storing the aforesaid state-checking table.

Referring to Table 1 and Table 2, the processing module 32 can be applied to locate the initial-stage loading levels for the refrigeration appliances 1a, 1b, 1c, 1d, 1e, 1f. The initial-stage loading levels for the refrigeration appliances 1a, 1b, 1c, 1d, 1e, 1f can be listed in Table 3 as follows.

TABLE 3

| | Comparison | | |
|---|---|---|---|
| | result upon | Comparison | |
| Refrigeration | Refrigeration | result upon | Initial-stage |
| appliance | parameters | Downtime | loading level |
| 1a | Idle | Idle | 1 |
| 1b | Idle | Busy | 2 |
| 1c | Busy | Idle | 3 |
| 1d | Busy | Idle | 3 |
| 1e | Busy | Idle | 3 |
| 1f | Busy | Idle | 3 |

It shall be explained that, in Table 3, the loading level 4 is not shown to any of the refrigeration appliances. However, if both the refrigeration parameter and the comparison result upon the downtime for a specific refrigeration appliance are “Busy”, then the loading level of this specific refrigeration appliance would be 4.

The play module 4a, 4b, 4c, 4d, 4e or 4f is utilized for broadcasting information of the corresponding loading levels. In this embodiment, the play module 4a includes a displaying unit 41a, a speaking unit 42a and a detecting unit 43a. Similarly, each of the other play modules 4b, 4c, 4d, 4e, 4f includes a displaying unit 41b, 41c, 41d, 41e, 41f, a speaking unit 42b, 42c, 42d, 42e, 42f and a detecting unit 43b, 43c, 43d, 43e, 43f, respectively.

By having the play module 4a as a typical example, the displaying unit 41a can display directly the initial-level information of the corresponding refrigeration appliance 1a; i.e., “1”. At this time, the initial-level information utilizes a literal symbol to express the initial-stage loading level. The speaking unit 42a can be utilized for broadcasting directly the initial-level information of the corresponding initial-stage loading level for the respective refrigeration appliances 1a. For example, the speaking unit 42a would voice play the message “the initial-stage loading level of the refrigeration appliance is 1” or a similar information. Namely, the initial-level information to be broadcast for the corresponding initial-stage loading level is voiced. The detecting unit 43a is utilized for detecting whether or not a user is located close to the refrigeration appliance 1a, and, if positive, for activating the speaking unit 42a to generate a trigger signal for initiating the broadcasting of the corresponding initial-level information.

Similarly, any of the other play modules 4b, 4c, 4d, 4e, 4f is structured and functioned as the foregoing play module 4a, and thus details thereabout are omitted herein.

Hence, after the play modules 4a, 4b, 4c, 4d, 4e, 4f play individually the initial-level information of the corresponding initial-stage loading levels for the respective refrigeration appliances 1a, 1b, 1c, 1d, 1e, 1f, then the initial-stage loading levels of the refrigeration appliances 1a, 1b, 1c, 1d, 1e, 1f can be publicly acknowledged, so that food materials can be stored into the corresponding refrigeration appliances accordingly with lower initial-stage loading levels. In this embodiment, the initial-stage loading levels for the refrigeration appliances 1a, 1b, 1c, 1d, 1e, 1f are listed as “1”, “2”, “3”, “3”, “3” and “3”, respectively. Thus, the food materials would be firstly stored into the refrigeration appliances 1a with the initial-stage loading level “1”, and then the refrigeration appliance 1b with the initial-stage loading level “2”.

It shall be explained that the embodiment of the play module 4a is not limited to include simultaneously the displaying unit 41a, the speaking unit 42a and the detecting unit 43a. In some other embodiments, the play module 4a can include simply only one of the displaying unit 41a and the speaking unit 42a, or merely both of the detecting unit 43a and the speaking unit 42a.

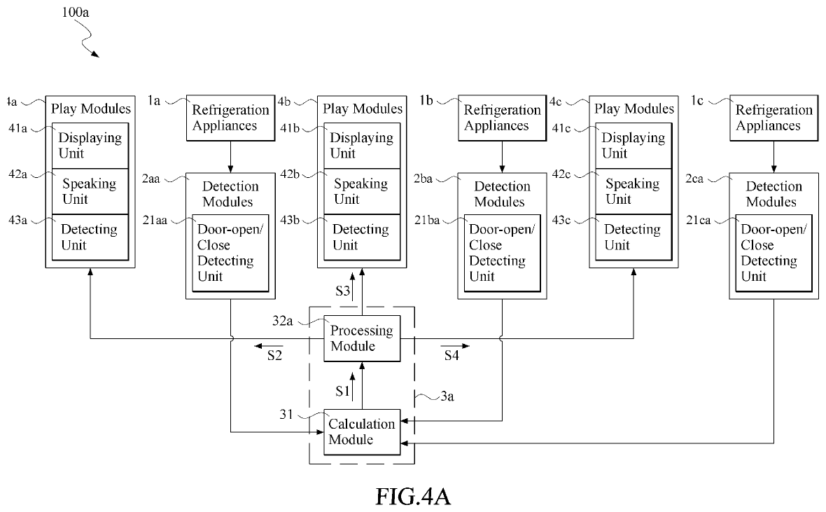

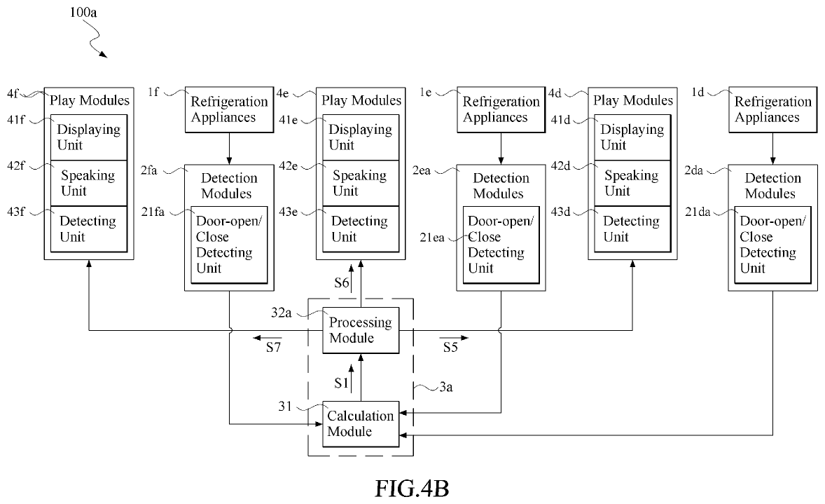

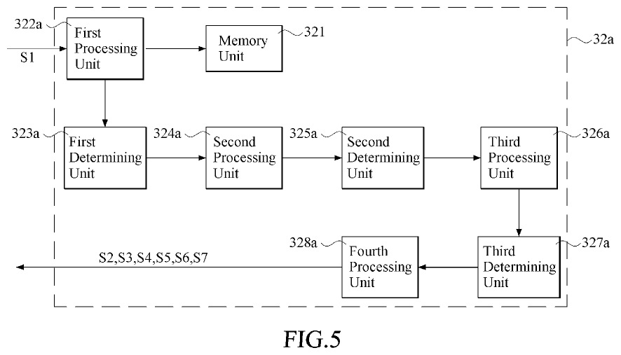

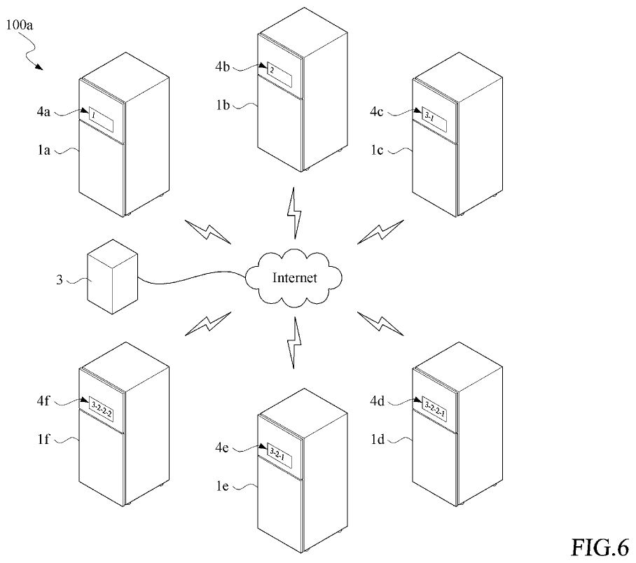

Finally, refer to FIG. 1, FIG. 2A, FIG. 2B, FIG. 4A, FIG. 4B, FIG. 5 and FIG. 6; where FIG. 4A and FIG. 4B together show schematically a block view of a second embodiment of the system for determining a loading level of a refrigeration appliance in accordance with the present invention, FIG. 5 is a schematic block view of the processing module of the second embodiment of FIG. 4A and FIG. 4B, and FIG. 6 is a schematic view of the second embodiment of FIG. 4A and FIG. 4B. As shown, in this embodiment, the system for determining a loading level of a refrigeration appliance 100a is largely resembled to the system 100 shown in FIG. 2A and FIG. 2B. Major difference in between is at the detection modules 2aa, 2ba, 2ca, 2da, 2ea, 2fa and the server 3a.

The detection module 2aa includes a door-open/close detecting unit 21aa. Similarly, the detection modules 2ba, 2ca, 2da, 2ea, 2fa includes door-open/close detecting units 21ba, 21ca, 21da, 21ea, 21fa, respectively. The door-open/close detecting units 21aa, 21ba, 21ca, 21da, 21ea, 21fa are individually utilized for detecting preceding door-open/close timing points of the corresponding refrigeration appliances 1a, 1b, 1c, 1d, 1e, 1f, respectively.

The difference between the server 3a and the server 3 exists at the processing module 32a. In this embodiment, the processing module 32a includes a memory unit 321, a first processing unit 322a, a first determining unit 323a, a second processing unit 324a, a second determining unit 325a, a third processing unit 326a, a third determining unit 327a and a fourth processing unit 328a. In this embodiment, the memory unit 321 is the same as that of the first embodiment, and thus details thereabout are omitted herein.

The first processing unit 322a utilizes the state-checking table to locate the initial-stage loading levels for the corresponding refrigeration appliances 1a, 1b, 1c, 1d, 1e, 1f. The aforesaid examples (including those listed in Table 1, Table 2 and Table 3) for the first embodiment will be still used in this second embodiment.

The first determining unit 323a, coupled signally with the first processing unit 322a, is utilized for generating a first processing signal upon when at least two of the initial-stage loading levels are identical. In this embodiment, the initial-stage loading levels for the refrigeration appliances 1c, 1d, 1e, 1f are all “3”, and thus the first determining unit 323a would generate the first processing signal.

The second processing unit 324a, coupled signally with first determining unit 323a, is utilized for further comparing the refrigeration appliances 1c, 1d, 1e and 1f with the same initial-stage loading level, upon when the first processing signal is received. In this embodiment, the second processing unit 324a would further compare the preceding downtime for the refrigeration appliances 1c, 1d, 1e, 1f, so that a first advanced-stage loading level for each of the refrigeration appliances 1c, 1d, 1e, 1f can be obtained, as listed in Table 4. In addition, each of the play modules 4c, 4d, 4e, 4f plays individual first advanced-stage information corresponding to the respective first advanced-stage loading level. The preceding downtime for the refrigeration appliance 1c is 40, which is higher that 30 for any of the refrigeration appliances 1d, 1e, 1f. It implies an idle degree of the refrigeration appliance 1c is higher than that of any of the refrigeration appliances 1d, 1e, 1f.

TABLE 4

| | Preceding | | | First |
|---|---|---|---|---|
| Refrigeration | refrigeration | Preceding | Initial-stage | advanced-stage |
| appliance | parameter | downtime | loading level | loading level |
| 1c | 180000 | 40 | 3 | 1 |
| 1d | 135000 | 30 | 3 | 2 |
| 1e | 90000 | 30 | 3 | 2 |
| 1f | 135000 | 30 | 3 | 2 |

The second determining unit 325a, coupled signally with the second processing unit 324a, is utilized for generating a second processing signal upon when at least two of the first advanced-stage loading levels are determined to be identical. In this embodiment, the first advanced-stage loading level for any of the refrigeration appliances 1d, 1e, 1f is “2”, and thus the second determining unit 325a would generate the second processing signal. The third processing unit 326a, coupled signally with the second determining unit 325a, is utilized for further determining whether or not the first advanced-stage loading levels for the corresponding refrigeration appliances 1d, 1e, 1f are identical after the second processing signal is received. In this embodiment, the third processing unit 326a would further compare the preceding refrigeration parameters of the corresponding refrigeration appliances 1d, 1e, 1f so as to obtain a second advanced-stage loading level for each of the refrigeration appliances 1d, 1e, 1f, as listed in Table 5. In addition, the play modules 4d, 4e, 4f plays the individual second advanced-stage information corresponding to the respective second advanced-stage loading levels. As shown, the refrigeration parameter of the refrigeration appliance 1d (90000) is lower than that of any of the refrigeration appliances 1e, 1f (135000). It implies that the idle degree of the refrigeration appliance 1d is further higher that of any of the refrigeration appliances 1e, 1f.

TABLE 5

| | | | First | Second |
|---|---|---|---|---|
| | Preceding | Initial- | advanced- | advanced- |
| Refrigeration | refrigeration | stage loading | stage loading | stage loading |
| appliance | parameter | level | level | level |
| 1d | 135000 | 3 | 2 | 2 |
| 1e | 90000 | 3 | 2 | 1 |
| 1f | 135000 | 3 | 2 | 2 |

The third determining unit 327a, coupled signally with the third processing unit 326a, is utilized for generating a third processing signal upon when at least two of the second advanced-stage loading levels are determined to be identical. In this embodiment, the second advanced-stage loading levels for the refrigeration appliances 1d, 1f are the same, and thus the third determining unit 327a would generate the third processing signal. The fourth processing unit 328a, coupled signally with the third determining unit 327a, is utilized for further determining whether or not the second advanced-stage loading levels for the corresponding refrigeration appliances 1d, 1f are identical after the third processing signal is received. In this embodiment, the fourth processing unit 328a would further compare the preceding door-close time intervals of the corresponding refrigeration appliances 1d, 1f, so that a final-stage loading level for each of the refrigeration appliances 1d, 1f would be obtained, as listed in Table 6. In addition, the play modules 4d, 4f play individual final-stage information of the corresponding final-stage loading levels. The preceding door-close time interval of the refrigeration appliance 1d is greater than that of the refrigeration appliance 1f. In order to avoid a big door-open/close number for any specific refrigeration appliance, thus the final-stage loading level for the refrigeration appliance 1d shall be superior to that of the refrigeration appliance 1f.

TABLE 6

| | Preceding | Initial- | First | Second | Final- |
|---|---|---|---|---|---|
| | door-open/ | stage | advanced- | advanced- | stage |
| Refrigeration | close time | loading | stage loading | stage loading | loading |
| appliance | interval | level | level | level | level |
| 1d | 10 | 3 | 2 | 2 | 1 |
| 1f | 5 | 3 | 2 | 2 | 2 |

Thus, the system 100a for determining a loading level of a refrigeration appliance can be used to determine the initial-stage loading levels for the refrigeration appliances 1a, 1b, 1c, 1d, 1e, 1f. Further, the preceding downtime, the preceding refrigeration parameter and the preceding door-close time interval are used to determine the corresponding first advanced-stage loading level, the second advanced-stage loading level and the final-stage loading level, as listed in Table 7.

TABLE 7

| | Preceding | | First | Second |
|---|---|---|---|---|
| | door-open/ | Initial- | advanced- | advanced- |
| Refrigeration | close time | stage loading | stage loading | stage loading |
| appliance | interval | level | level | level |
| 1a | 1 | — | — | — |
| 1b | 2 | — | — | — |
| 1c | 3 | 1 | — | — |
| 1d | 3 | 2 | 2 | 1 |
| 1e | 3 | 2 | 1 | — |
| 1f | 3 | 2 | 2 | 2 |

Furthermore, in detail, referring to FIG. 4A, FIG. 4B and FIG. 5, the calculation module 31 would transmit the signal S1 to the first processing unit 322a of the processing module 32a. The signal S1 would go through the first determining unit 323a, the second processing unit 324a, the second determining unit 325a, the third processing unit 326a and the third determining unit 327a, and finally the signal S1 would go through the fourth processing unit 328a to for generating signals S2, S3, S4, S5, S6 and S7. The signals S2, S3, S4, S5, S6, S7 would be transmitted to the play modules 4a, 4b, 4c, 4d, 4e, 4f, respectively.

Therefore, the play modules 4a, 4b would play individually the initial-level information represented by “1” and “2”, respectively. The play module 4c would play both the “3” initial-level information and the “1” first advanced-stage information. The play module 4e would play the “3” initial-level information, the “2” first advanced-stage information and the “1” second advanced-stage information. Each of the play modules 4d and 4f would play the “3” initial-level information, the “2” first advanced-stage information, the “2” second advanced-stage information, and the final-stage information. In addition, the play module 4d would further play the “1” final-stage information, and the play module 4f would further play the “:2” final-stage information. For example, as shown in FIG. 6, the play modules 4d would play orderly the “3-2-2-1” information, in which a “-” may be used to separate two consecutive information.

In summary, the system for determining a loading level of a refrigeration appliance provided by the present invention can play all the initial-stage loading levels for the corresponding refrigeration appliances. In other words, the priority for utilizing the refrigeration appliances is displayed as well. Thus, food materials can be prevented from being stored into a refrigeration appliance having a higher initial-stage loading level, or from being stored into the same refrigeration appliance (for example, a nearby refrigeration appliance), from any of which the specific refrigeration appliance may be stacked with excessive food materials, or be frequently opened and closed. Namely, in accordance with the present invention, the long-concerned shortcomings in freshness of food materials and energy consumption to a specific refrigeration appliance can be substantially resolved.

In addition, the system for determining a loading level of a refrigeration appliance provided by the present invention can further utilize the preceding downtime, the preceding refrigeration parameter and the preceding door-close time interval to realize the first advanced-stage loading level, the second advanced-stage loading level and the final-stage loading level for each of the refrigeration appliances, such that the priority of the refrigeration appliances for storing additional food materials can be determined. Also, the problem for a single refrigeration appliance to store excessive food materials, or other problems in frequent door opening and closing, high energy consumption and extended downtime can be significantly improved.

While the present invention has been particularly shown and described with reference to a preferred embodiment, it will be understood by those skilled in the art that various changes in form and detail may be without departing from the spirit and scope of the present invention.

What is claimed is:

1. A system for determining a loading level of a refrigeration appliance, comprising:
a plurality of refrigeration appliances, each of the plurality of refrigeration appliances running for a cycle number of work cycles within a statistic time duration, each of the work cycles having a work-cycling time and a refrigeration parameter, the work-cycling time being consisted of a refrigeration time and a downtime, a most recent work cycle of the work cycles being defined as a preceding work cycle, the refrigeration parameter and the downtime corresponding to the preceding work cycle being defined as a preceding refrigeration parameter and a preceding downtime, respectively;
a plurality of detection modules, each of the plurality of detection modules being utilized for detecting the cycle number of each of the plurality of refrigeration appliances, and for detecting the refrigeration parameter and the downtime for each of the work cycles;
a server, coupled signally with the plurality of refrigeration appliances and the plurality of detection modules, utilized for receiving the cycle number, the refrigeration parameter and the downtime for each of the work cycles, the preceding refrigeration parameter and the preceding downtime of each of the plurality of refrigeration appliances, including:
a calculation module, for averaging individually the refrigeration parameters and the downtime for all the work cycles within the statistic time duration to obtain a refrigeration parameter average and a downtime average; and
a processing module, coupled signally with the calculation module, utilized for generating a comparison result upon the refrigeration parameters by comparing the preceding refrigeration parameters and the refrigeration parameter average, for generating a comparison result upon the downtime by comparing the preceding downtime and the downtime average, and for searching an initial-stage loading level for each of the plurality of refrigeration appliances from a state-checking table according to the comparison result upon the refrigeration parameters and the comparison result upon the downtime; and
a plurality of play modules, disposed individually at the plurality of refrigeration appliances, utilized for playing individual initial-level information corresponding to the respective initial-stage loading level for each of the plurality of refrigeration appliances;
wherein the refrigeration parameter for each of the plurality of refrigeration appliances within the statistic time duration is a sum of individual products of the rotational speeds and the corresponding running time of each of the plurality of refrigeration appliance within the statistic time duration.

2. The system of claim 1, wherein the processing module includes a memory unit for storing the state-checking table.

3. The system of claim 1, wherein the processing module includes a first processing unit for locating the initial-stage loading level for each of the plurality of refrigeration appliances from the state-checking table so as to obtain a plurality of the initial-stage loading levels.

4. The system of claim 3, wherein the processing module further includes:
a first determining unit, coupled signally with the first processing unit, utilized for generating a first processing signal upon when at least two of the plurality of the initial-stage loading levels are identical; and
a second processing unit, coupled signally with the first determining unit, utilized for further comparing the preceding downtime for the plurality of refrigeration appliances with the same initial-stage loading level, upon when the first processing signal is received, so as to obtain a first advanced-stage loading level for each of the plurality of refrigeration appliances, and to have each of the plurality of play modules to further play first advanced-stage information corresponding to the first advanced-stage loading level for the respective each of the plurality of refrigeration appliances.

5. The system of claim 4, wherein the processing module further includes:
a second determining unit, coupled signally with the second processing unit, utilized for generating a second processing signal upon when at least two of the plurality of the first advanced-stage loading levels are identical; and
a third processing unit, coupled signally with the second determining unit, utilized for further comparing the refrigeration parameters for the plurality of refrigeration appliances with the same first advanced-stage loading level, upon when the second processing signal is received, so as to obtain a second advanced-stage loading level for each of the plurality of refrigeration appliances, and to have each of the plurality of play modules to further play second advanced-stage information corresponding to the second advanced-stage loading level for the respective each of the plurality of refrigeration appliances.

6. The system of claim 5, wherein each of the plurality of detection modules includes a door-open/close detecting unit for detecting a preceding door-close time interval of a corresponding one of the plurality of refrigeration appliances.

7. The system of claim 6, wherein the processing module further includes:
a third determining unit, coupled signally with the third processing unit, utilized for generating a third processing signal upon when at least two of the plurality of the second advanced-stage loading levels are identical; and
a fourth processing unit, coupled signally with the third determining unit, utilized for further comparing the preceding door-close time intervals for the plurality of refrigeration appliances with the same second advanced-stage loading level, upon when the third processing signal is received, so as to obtain a final-stage loading level for each of the plurality of refrigeration appliances, and to have each of the plurality of play modules to further play final-stage information corresponding to the final-stage loading level for the respective each of the plurality of refrigeration appliances.

8. The system of claim 1, wherein each of the plurality of play modules includes a displaying unit for playing the initial-level information.

9. The system of claim 1, wherein each of the plurality of play modules includes a speaking unit for voice playing the initial-level information.

10. The system of claim 9, wherein each of the plurality of play modules includes a detecting unit coupled signally with the speaking unit and utilized for activating the speaking unit to generate a trigger signal for initiating broadcasting of the corresponding initial-level information.
